(19) United States
(12) Patent Application Publication
(10) Pub. No.: US 2024/0004679 A1
(43) Pub. Date: Jan. 4, 2024

(54) Accelerating Networking by Multiplexing Driver Data Paths

(71) Applicant: Microsoft Technology Licensing, LLC, Redmond, WA (US)

(72) Inventors: Omar CARDONA, Bellevue, WA (US); Narcisa Ana Maria VASILE, Redmond, WA (US)

(73) Assignee: Microsoft Technology Licensing, LLC, Redmond, WA (US)

(21) Appl. No.: 17/809,627

(22) Filed: Jun. 29, 2022

(51) Int. Cl. G06F 9/455

(52) U.S. Cl. CPC G06F 9/45558; G06F 9/45545; G06F 2009/4557; G06F 2009/45579; G06F 2009/45595

(57) ABSTRACT

Examples of the present disclosure describe systems and methods for multiplexing driver data paths. In examples, an application in a virtual machine provides data packets to a driver multiplexer implemented in user space of the virtual machine. The driver multiplexer determines whether a virtual function is available for transmitting the data packets. If the virtual function is available, the driver multiplexer provides the data packets to the virtual function in user space of the virtual machine. The virtual function provides the data packets to a physical network interface card of the device hosting the virtual machine. If the virtual function driver is unavailable, the driver multiplexer uses a raw socket driver to provide the data packets to a raw socket in kernel space of the virtual machine. The raw socket provides the data packets to a network virtual client, which provides the data packets to the physical network interface card.

### BACKGROUND

As network adapters become faster, compute processing overhead for processing data packets transmitted by network adapters increases. To increase network performance, virtual functions are used to bypass the kernel and transmit data packets from the network interface card into user space.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for multiplexing driver data paths. In examples, an application in user space of a virtual machine provides data packets to a driver multiplexer implemented in the user space of the virtual machine. The driver multiplexer determines whether a virtual function implemented in the user space of the virtual machine is available for transmitting the data packets. If the virtual function is available, the driver multiplexer uses a virtual function driver to provide the data packets to the virtual function. The virtual function provides the data packets to a physical network interface card of the device hosting the virtual machine. If the virtual function driver is unavailable, the driver multiplexer uses a raw socket driver implemented in the user space of the virtual machine to provide the data packets to a raw socket implemented in kernel space of the virtual machine. The raw socket provides the data packets to a network virtual client that is also implemented in the kernel space of the virtual machine. The network virtual client encapsulates the data packets and provides the encapsulated data packets to a virtual switch external to the virtual machine. The virtual switch provides the data packets to a physical network interface card of the device hosting the virtual machine.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an overview of an example host device for multiplexing driver data paths.

FIG. 2 illustrates an example system for multiplexing driver data paths.

FIGS. 3A and 3B illustrate example data flows for transmitting a data packet via a raw socket data path using the multiplexing driver data paths techniques described herein.

FIGS. 4A and 4B illustrate example data flows for transmitting a data packet using a virtual function data path using the multiplexing driver data paths techniques described herein.

FIG. 5 illustrates an example method for multiplexing driver data paths.

FIG. 6 illustrates an alternative example method for multiplexing driver data paths.

FIG. 7 is a block diagram illustrating example physical components of a computing device for practicing aspects of the disclosure.

FIGS. 8A and 8B are simplified block diagrams of an example mobile computing device for practicing aspects of the present disclosure.

FIG. 9 is a simplified block diagram of an example distributed computing system for practicing aspects of the present disclosure.

FIG. 10 illustrates an example tablet computing device for executing one or more aspects of the present disclosure.

### DETAILED DESCRIPTION

As the data transmission speed of network adapters increases, the overhead introduced by the kernel network stack becomes non-negligible. To increase network performance, solutions such as virtual functions (VFs) focus on bypassing the kernel and transmitting data packets from the network interface card into user space with minimal operating system (“OS”) interference. VFs are virtual instances of a physical network adapter that can be exposed inside virtual machines (VMs). A VM, as used herein, refers to a virtual computer system that emulates the functionality of a physical computer. VFs enable data packets to be sent from the hardware of a computing device that is hosting a VM (“host device”) directly into the VM, bypassing the host device kernel network stack. Poll Mode Drivers (PMDs) implemented in user space of the VM receive the data packets and transmit the data packets to an application executing in the VM. However, as a VF can be dynamically added to or removed from the VM at any time, a fallback data path for transmitting data packets to/from the VM is needed to prevent an immediate connectivity loss to the user space of the VM when the VF is removed.

The present disclosure provides a solution that increases reliability and performance as compared to previous solutions. In embodiments of the present disclosure, an application executing in the user space of a VM provides data packets to a driver multiplexer that is also implemented in the user space of the VM. The driver multiplexer determines whether a VF is available for transmitting the data packets. If the driver multiplexer determines a VF is available, the driver multiplexer uses a VF driver to provide the data packets to a VF in kernel space of the VM. A driver, as used herein, refers to a software component that enables an OS or an application to access hardware functions of a computing device without requiring the OS or application to have precise details about the hardware being used. The VF provides the data packets to a physical NIC of the host device hosting the VM.

If the driver multiplexer determines a VF is unavailable, the driver multiplexer uses a raw socket driver to provide the data packets to a raw socket in kernel space of the VM. A raw socket, as used herein, refers to an interface that provides an application direct access to data packets received at the Ethernet layer, thereby enabling the application to bypass the normal TCP/IP processing of the data packets. The raw socket provides the data packets to a network virtual client in the kernel space of the VM. The network virtual client encapsulates the data packets and provides the encapsulated data packets to a virtual switch external to the VM. In an example, the virtual switch is located in a virtual environment provided by a hypervisor of the host device. The virtual switch provides the data packets to a physical NIC of the host device.

Accordingly, the present disclosure describes a driver multiplexer that provides a single stable, performant data path. The driver multiplexer abstracts the complexities of managing the VF away from the application executing in the VM, which increases the performance of the application and the improves the management of the VF (as the driver multiplexer functions as a dedicated VF manager). Further, the driver multiplexer does not reconfigure or require the reconfiguration of the network virtual client, which, in some examples, is robust and has been proven effective and secure over time. Thus, the driver multiplexer enables continued use of a known, trusted network virtual client.

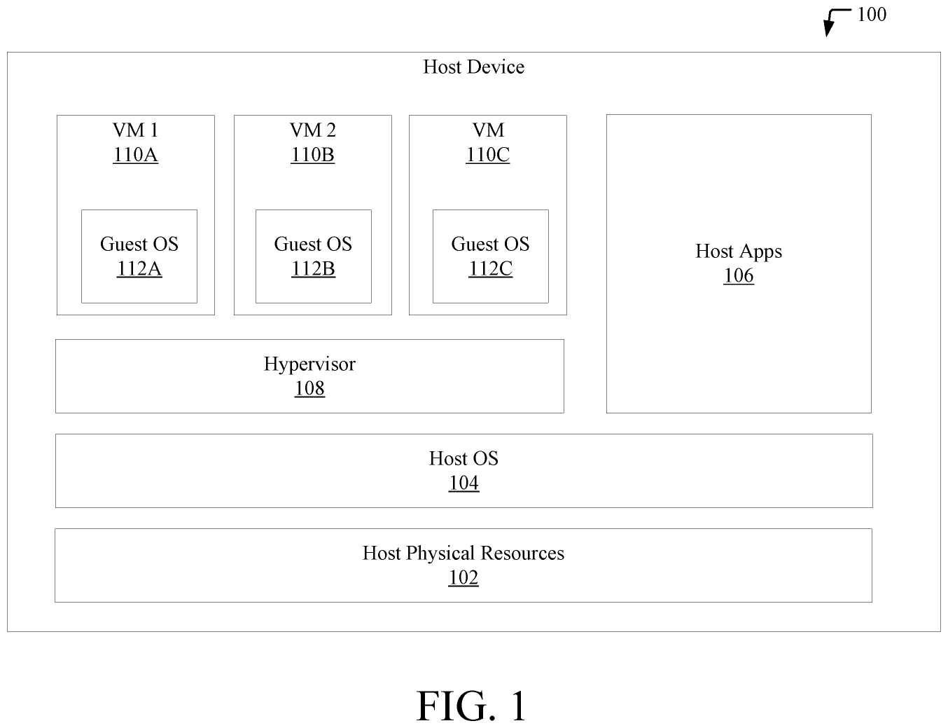

FIG. 1 illustrates a host device 100 for multiplexing driver data paths. Example host device 100 as presented is a combination of interdependent components that interact to form an integrated whole. Components of host device 100 may be hardware components or software components (e.g., applications, application programming interfaces (APIs), modules, VMs, or runtime libraries) implemented on and/or executed by hardware components of host device 100. In one example, components of host device 100 are distributed across multiple processing devices.

In FIG. 1, host device 100 comprises host physical resources 102, host OS 104, host applications 106, hypervisor 108, and VMs 110A, 110B, and 110C (collectively referred to as “VM(s) 110”). The scale and structure of devices, environments, and systems discussed herein may vary and may include additional or fewer components than those described in FIG. 1 and subsequent figures. Further, although examples in FIG. 1 and subsequent figures will be discussed in the context of VMs, the examples are equally applicable to other contexts, such as containers (or other virtual resources) and those contexts that do not implement virtual environments or virtual components. Examples of host device 100 include personal computers (PCs), server devices, mobile devices (e.g., smartphones, tablets, laptops, personal digital assistants (PDAs)), wearable devices (e.g., smart watches, smart eyewear, fitness trackers, smart clothing, body-mounted devices, head-mounted displays), gaming consoles or devices, and Internet of Things (IoT) devices.

Host physical resources 102 include processing hardware (e.g., a central processing unit (CPU), a graphics processing unit (GPU), a video card), memory, persistent storage, a network interface, and the like. In examples, host physical resources 102 are directly accessible by host OS 104, host applications 106, and hypervisor 108, and are not directly accessible by VM(s) 110. Instead, VM(s) 110 indirectly access host physical resources 102 via a component of host device 100, such as hypervisor 108.

Host OS 104 provides software for performing various computing functions, such as executing host applications 106, executing hypervisor 108, scheduling tasks, and controlling peripherals (e.g., microphones, touch-based sensors, geolocation sensors, accelerometers, optical/magnetic sensors, gyroscopes, keyboards, and pointing/selection tools). Host OS 104 is configured to receive input data (e.g., audio input, touch input, text-based input, gesture input, and/or image input) from a user or a computing device. In some examples, the input data corresponds to user interaction with host applications 106 or hypervisor 108. In other examples, the input data corresponds to automated interaction with services or host applications 106, such as the automatic (e.g., non-manual) execution of scripts or sets of commands at scheduled times or in response to predetermined events.

Host applications 106 may be implemented locally on host device 100 or accessible remotely by host device 100 via a network, such as a private area network (PAN), a local area network (LAN), a wide area network (WAN), and the like. Host applications 106 provide access to a set of software and/or hardware functionality. Examples of host applications 106 include applications and services relating to word processing, spreadsheets, presentation software, document-reading, social media software or platforms, search engines, media software or platforms, multimedia players, content design software or tools, database software or tools, provisioning software, and alert or notification software.

Hypervisor 108 is software that creates, executes, and manages VM(s) 110 within an execution environment of host device 100. Hypervisor 108 exposes VM(s) 110 to one or more networks in order to enable VM(s) 110 to communicate amongst each other and to communicate with other devices or components of or external to host device 100. In examples, hypervisor 108 provides VM(s) 110 access to host physical resources 102 and/or the physical resources of computing devices external to host device 100.

VM(s) 110 are compute resources that use software instead of a physical computing device to execute and deploy applications. VM(s) 110 comprise guest OS 112A, 112B, and 112C (collectively referred to as “guest OS 112”). Each guest OS 112 comprises a kernel space and a user space. The kernel space is reserved for executing a privileged OS kernel, kernel extensions, and most device drivers. The user space is reserved for executing application software and non-privileged device drivers. In examples, guest OS 112 implements or has access to applications, such as described with respect to host applications 106. Each guest OS 112 may comprise or provide access to a different set of applications.

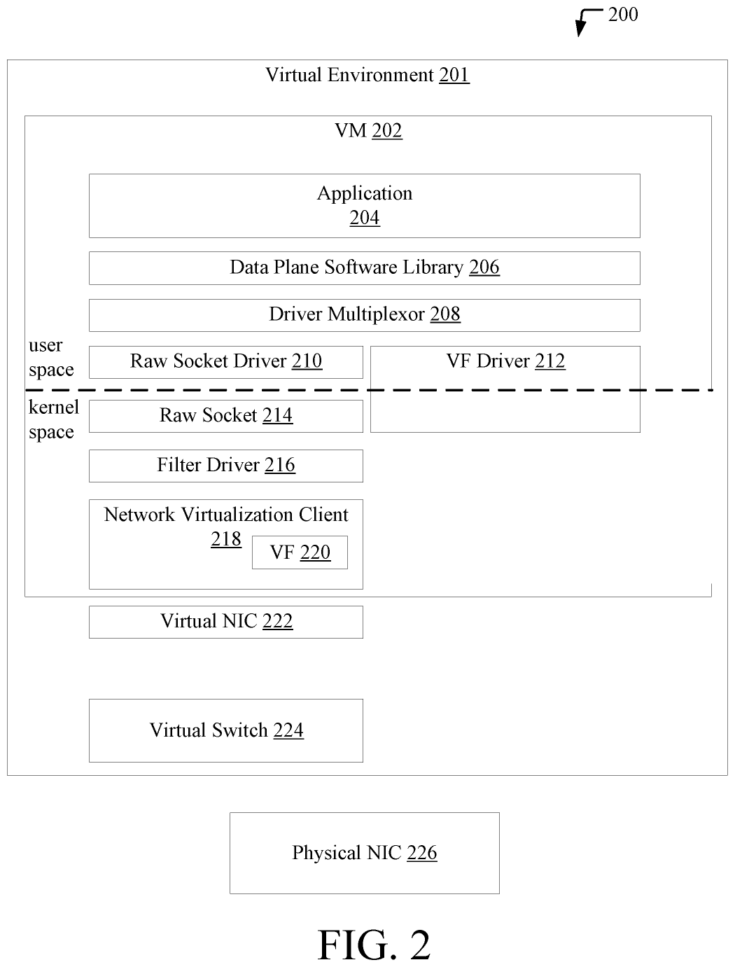

FIG. 2 illustrates a system for multiplexing driver data paths. Example system 200 may be hardware components or software components implemented on and/or executed by hardware components of host device 100. Alternatively, one or more components of system 200 may be distributed across multiple processing devices.

In FIG. 2, system 200 comprises virtual environment 201 and physical NIC 226. Virtual environment 201 and physical NIC 226 are implemented in a host device, such as host device 100. Virtual environment 201 is managed (e.g., created, modified, removed) by a hypervisor or a similar hardware/software emulator component of the host device. Virtual environment 201 comprises VM 202. In examples, VM 202 implements an operating system comprising a kernel space and a user space. The user space of VM 202 comprises application 204, data plane software library 206, driver multiplexor 208, raw socket driver 210, and VF driver 212. The kernel space of VM 202 comprises VF driver 212, raw socket 214, filter driver 216, network virtualization client 218, and VF 220. Virtual environment 201 further comprises virtual NIC 222 and virtual switch 224.

Application 204 provides access to a set of software and/or hardware functionality, as described with respect to host applications 106. In examples, application 204 generates or receives data packets for input data associated with interaction with VM 202.

Data plane software library 206 facilitates the abstraction of kernel mode functionality of VM 202 to user space of VM 202. As one example, data plane software library 206 provides a set of data plane libraries and NIC PMDs for offloading TCP packet processing from the kernel space to the processes executing in the user space. A data plane, as used herein, refers to a part of a network through which data packets are transmitted. The offloading achieves higher computing efficiency and data packet throughput than can be achieved using the interrupt-driven processing provided in the kernel. Interrupt processing, as used herein, refers to a data processing method in which interrupt signal emitted by hardware or software alter (interrupt) the sequence a processor executes instructions.

Driver multiplexor 208 aggregates the available data paths for transmitting data packets generated or received by application 204 such that only a single available data path is visible to the data plane software library 206. Driver multiplexor 208 determines which data path to use to transmit data packets based on whether VF 220 is available to transmit the data packets. In various embodiments, the determination comprises evaluating a component registry comprising entries for registered or active components of VM 202, querying network virtualization client 218, and/or evaluating response messages (e.g., success, failure, acknowledge) received in response to providing data packets to VF 220, among other options. In examples, if VF 220 is determined to be available to transmit the data packets, driver multiplexor 208 selects the VF data path to transmit the data packets. If VF 220 is determined to be unavailable to transmit the data packets, driver multiplexor 208 selects the raw socket data path to transmit the data packets.

Raw socket driver 210 provides interfaces, such as APIs, that enable application 204 (and other components of the OS of VM 202) to access hardware functions of a computing device hosting VM 202. As one example, raw socket driver 210 creates and binds raw socket 214 to a specific data packet transmission queue used by VM 202, which enables data plane software library 206 and/or driver multiplexor 208 to send and receive data packets through raw socket 214. In such as example, raw socket driver 210 provides access to a raw socket data path (via raw socket 214) that is a synthetic data path (e.g., the entire data path is software). The synthetic data path causes computational overhead, which is a limiting factor to achieving a very low CPU utilization and very high packet rates.

VF driver 212 is shared across user space and kernel space of VM 202 and provides interfaces, as discussed with respect to raw socket driver 210. The interfaces provided by VF driver 212 enable data plane software library 206 and/or driver multiplexor 208 to communicate with VF 220. VF driver 212 provides access to a VF data path (via VF 220) that is a hardware data path. The hardware data path provides faster data transmission speed than available using synthetic data path. In examples, VF driver 212 and/or raw socket driver 210 are PMDs configured for fast packet processing and low latency by bypassing the kernel network stack of VM 202 and avoiding the performance overhead of interrupt processing.

Raw socket 214 receives and transmits data packets through the kernel space of VM 202. In examples, the data packets include raw Ethernet frames. A raw Ethernet frame refers to a data link layer protocol data unit that is transported using Ethernet physical layer transport mechanisms. Raw socket 214 transmits the raw Ethernet frames between user spaces and kernel space of VM 202.

Filter driver 216 enables access to data packets as the data packets are processed through the network stack of VM 202. As one example, filter driver 216 enables monitoring data packets and filtering the data packets based on specified criteria. Filter driver 216 also enables the modification of interactions between various drivers of VM 202.

Network virtualization client 218 is a virtual network device that provides networking functionality to a guest OS. As one example, network virtualization client 218 exposes a virtualized view of a physical network adapter on a host device by providing a miniport driver edge to the network stack of VM 202. The virtualized view corresponds to VF 220. Network virtualization client 218 encapsulates and/or decapsulates received data packets. As one example, for a data packet transmitted from application 204, network virtualization client 218 applies at least remote network driver encapsulation, virtual switch encapsulation, and VM bus encapsulation to the data packet. For a data packet transmitted to application 204, network virtualization client 218 applies at least VM bus decapsulation to the data packet, virtual switch decapsulation, and remote network driver decapsulation to the data packet.

VF 220 is a virtual instance of physical network adapter. In examples, VF 220 is a lightweight function, as the VF 220 comprises the necessary functionality for transmitting data packets while comprising a minimized set of configuration options. VF 220 enables data packets to be transmitted directly between hardware of a host device and user space of VM 202.

Virtual NIC 222 is a software NIC emulation that enables VM 202 to connect to a physical network via virtual switch 224. Virtual switch 224 is software that enables communication between VMs and connects VMs to physical networks. Virtual switch 224 may be bound to physical NIC 226. Physical NIC 226 is a physical resource of a host device and is outside the boundary of virtual environment 201. When bound to physical NIC 226, virtual switch 224 enables VM 202 to access a physical network accessible to the host device.

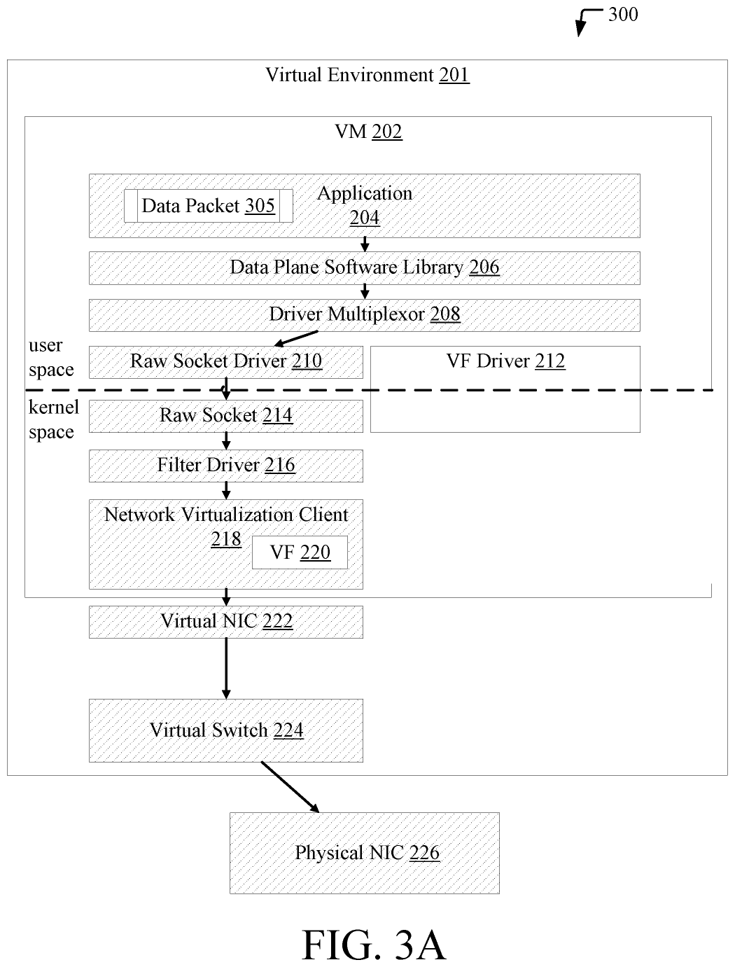

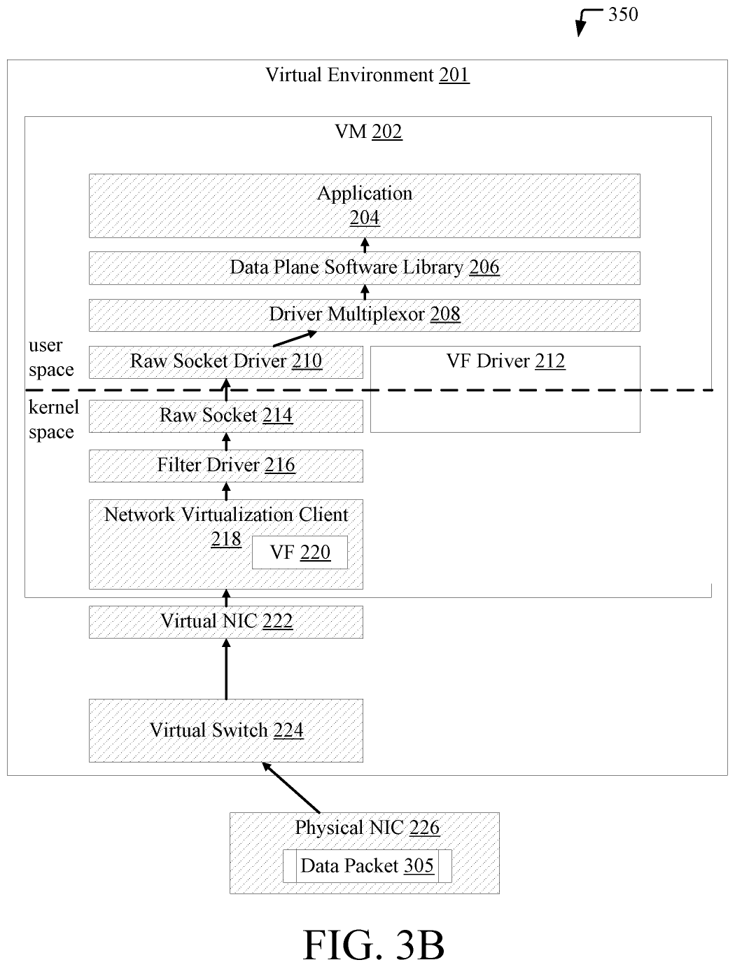

FIGS. 3A and 3B illustrate example data flows for transmitting a data packet through system 200 of FIG. 2 using the raw socket data path. FIG. 3A illustrates transmitting the data packet from application 204 to physical NIC 226. FIG. 3B illustrates transmitting the data packet from physical NIC 226 to application 204.

In FIG. 3A, example data flow 300 begins when application 204 generates or receives data packet 305. Data plane software library 206 transmits data packet 305 to driver multiplexor 208. Driver multiplexor 208 determines that VF 220 is not available and transmits data packet 305 to raw socket driver 210. Raw socket driver 210 enables data packet 305 to be transmitted from user space of VM 202 to raw socket 214 in kernel space of VM 202. Raw socket 214 provides data packet 305 to filter driver 216. In examples, the data path through raw socket driver 210, raw socket 214, and filter driver 216 constitutes a raw socket data path. Filter driver 216 or raw socket 214 transmits data packet 305 to network virtualization client 218. Network virtualization client 218 transmits data packet 305 beyond the boundary of VM 202 to virtual NIC 222, which transmits data packet 305 to virtual switch 224. Virtual switch 224 transmits data packet 305 beyond the boundary of virtual environment 201 to physical NIC 226. Physical NIC 226 transmits data packet 305 on towards a destination point.

In FIG. 3B, example data flow 350 begins when physical NIC 226 receives data packet 305. Physical NIC 226 transmits data packet 305 inside the boundary of virtual environment 201 to virtual switch 224. Virtual switch 224 transmits data packet 305 to virtual NIC 222. Virtual NIC 222 transmits data packet 305 inside the boundary of VM 202 to network virtualization client 218. In some examples, network virtualization client 218 transmits data packet 305 to filter driver 216, which then provides data packet 305 to raw socket 214. In other examples, network virtualization client 218 transmits data packet 305 to raw socket 214, which may then apply filter driver 216. In both examples, data packet 305 is transmitted from kernel space of VM 202 to driver multiplexor 208 in user space of VM 202 using raw socket driver 210. Data packet 305 is transmitted to application 204 using data plane software library 206.

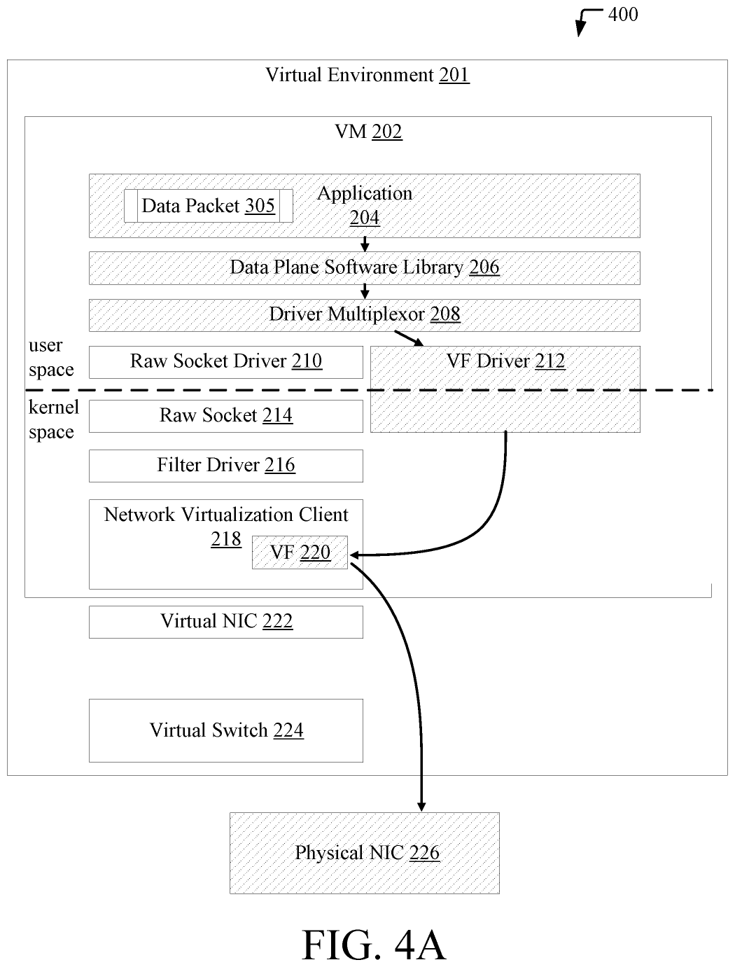

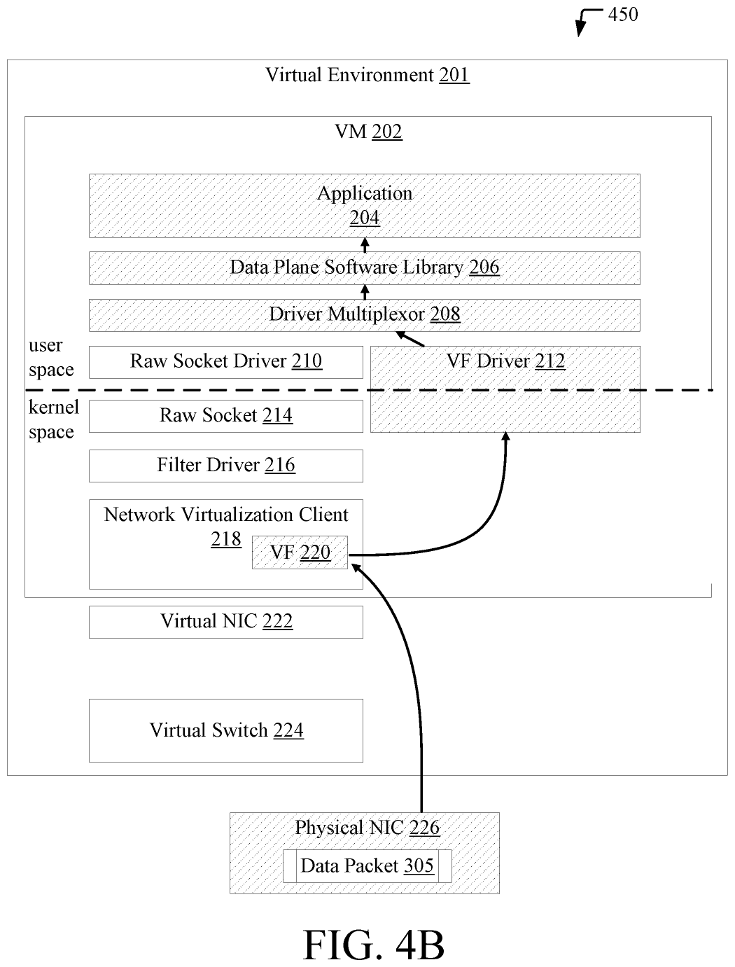

FIGS. 4A and 4B illustrate example data flows for transmitting a data packet through system 200 of FIG. 2 using the VF data path. FIG. 4A illustrates transmitting the data packet from application 204 to physical NIC 226. FIG. 4B illustrates transmitting the data packet from physical NIC 226 to application 204.

In FIG. 4A, example data flow 400 begins when application 204 generates or receives data packet 305 or receives data packet 305. Data plane software library 206 transmits data packet 305 to driver multiplexor 208. Driver multiplexor 208 determines that VF 220 is available and transmits data packet 305 to VF 220 using VF driver 212. VF driver 212 enables data packet 305 to be transmitted from user space of VM 202 to VF 220 in kernel space of VM 202. VF 220 transmits data packet 305 beyond the boundaries of VM 202 and virtual environment 201 to physical NIC 226. Physical NIC 226 transmits data packet 305 on towards a destination point.

In FIG. 4B, example data flow 450 begins when physical NIC 226 receives data packet 305. Physical NIC 226 transmits data packet 305 inside the boundaries of virtual environment 201 and VM 202 to VF 220. Data packet 305 is transmitted from kernel space of VM 202 to driver multiplexor 208 in user space of VM 202 using VF driver 212. Data packet 305 is transmitted to application 204 using data plane software library 206.

Having described one or more devices and systems that may employ aspects of the present disclosure, one or more methods for performing these aspects will now be described. In examples, methods 500 and 600 may be executed by a device, such as host device 100, or a system, such as system 200 of FIG. 2. However, methods 500 and 600 are not limited to such examples.

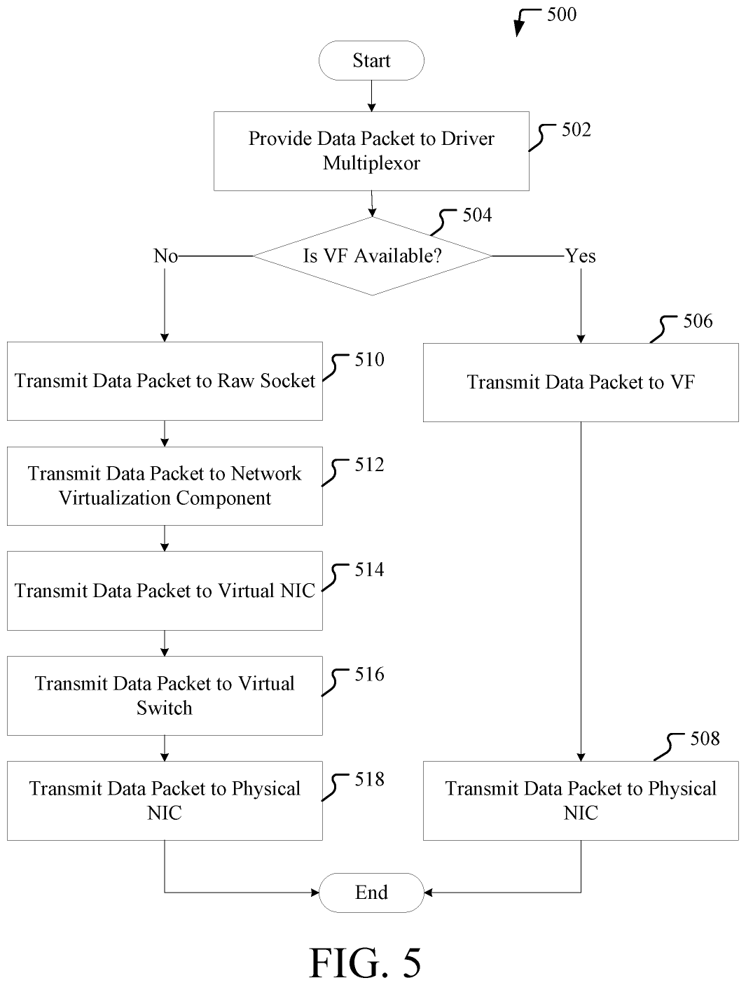

FIG. 5 illustrates an example method for multiplexing driver data paths. Example method 500 describes transmitting data packets from an application to a physical NIC. Method 500 begins at operation 502, where an application in user space of a computing environment provides data packets to a driver multiplexer in the user space of a computing environment. In examples, an application, such as application 204, receives or generates data packets. A software library, such as data plane software library 206, facilitates the transfer of the data packets to a driver multiplexer, such as driver multiplexor 208. In some examples, the application, the software library, and the driver multiplexer are implemented in a guest environment, such as VM 202, of a host device, such as host device 100. In other examples, the application and the software library are not implemented in a guest environment. Instead, these components are implemented in the host environment or in a computing environment that is not virtualized.

At operation 504, the driver multiplexer determines whether a VF for processing the data packets is available. The determination may comprise evaluating a component registry comprising entries for registered or active components of the guest environment, querying a network virtualization component, such as network virtualization client 218, and/or evaluating response messages (e.g., success, failure, acknowledge) received in response to attempting to provide data packets to a VF, such as VF 220. As one example, the driver multiplexer queries a network virtualization component that is configured to implement a VF to determine whether the VF (or the network virtualization component) is currently available. The network virtualization component provides a response to the query indicating whether the VF is available. As another example, the driver multiplexer provides one or more or the data packets or a test message to the VF. The driver multiplexer receives a status message (e.g., success, failure, acknowledge) indicating whether the data packets or test message was received by the VF.

If the driver multiplexer determines the VF is available, method 500 proceeds to operation 506. At operation 506, the data packets are provided to the VF using a VF driver, such as VF driver 212. In examples, the VF driver is shared across user space and kernel space of the guest environment and provides interfaces that enable the application to access hardware functions of a computing device hosting the guest environment (“host device”). The interfaces enable the data packets to be provided from the user space of the guest environment to the kernel space of the guest environment such that the data packets bypass the kernel network stack of the kernel space. In at least one example, the data packets are raw data packets that have not been encapsulated or have been minimally encapsulated.

At operation 508, the VF provides the data packets to a physical NIC. In examples, the VF transmits the data packets beyond the boundary of the guest environment to a physical NIC of a host device, such as physical NIC 226. The VF transmits the data packets such that the data packets bypass the kernel network stack of the host device. The physical NIC then transmits the data packets to a destination indicated by the application. The data packet data path described by operations 504, 506, and 508 constitutes a hardware data path that provides faster data transmission speed than available using the data packet data path described by operations 510, 512, 514, 516, and 518.

If, at operation 504, the driver multiplexer determines the VF is unavailable, method 500 proceeds to operation 510. In examples, the VF may be determined to be unavailable due to an operational failure of the VF or of the network virtualization component that is configured to implement the VF, an operational failure of a physical NIC of the host device, or maintenance performed on a component of the guest environment or host device (e.g., firmware updates, driver updates, settings modifications).

At operation 510, the data packets are provided to a raw socket, such as raw socket 214, using a raw socket interface, such as raw socket driver 210. In examples, the raw socket interface is implemented in user space of the guest environment and the raw socket is implemented in kernel space of the guest environment. In at least one example, the raw socket is associated with a filter mechanism, such as filter driver 216. The filter mechanism enables the data packets to be monitored and/or filtered as the data pockets are being transmitted via the raw socket.

At operation 512, the raw socket transmits the data packets to the network virtualization component. The network virtualization component performs one or more types of encapsulation on the data packets. As one example, the network virtualization component applies network driver encapsulation, virtual switch encapsulation, and VM bus encapsulation to the data packets.

At operation 514, the network virtualization component transmits the encapsulated data packets to a virtual NIC, such as virtual NIC 222. The virtual NIC is outside the boundary of the guest environment and facilitates communication between guest environments and between guest environments and physical networks. As one example, the virtual NIC is implemented in a virtual environment, such as virtual environment 201, of a host device and provides communication between the guest environment and a virtual switch. The virtual environment may be provided by a hypervisor or a similar hardware/software emulator component of a host device.

At operation 516, the virtual NIC transmits the encapsulated data packets to a virtual switch that is outside the boundary of the guest environment, such as virtual switch 224. In examples, the virtual switch is bound to a physical NIC of a host device.

At operation 518, the virtual switch transmits the encapsulated data packets to a physical NIC that is outside the boundary of the virtual environment in which the guest environment is implemented, such as physical NIC 226. The physical NIC transmits the data packets to a destination indicated by the application. The data packet data path described by operations 510, 512, 5124, 516, and 518 constitutes a synthetic data path that provides slower data transmission speed than available using the data packet data path described by operations 504, 506, and 508.

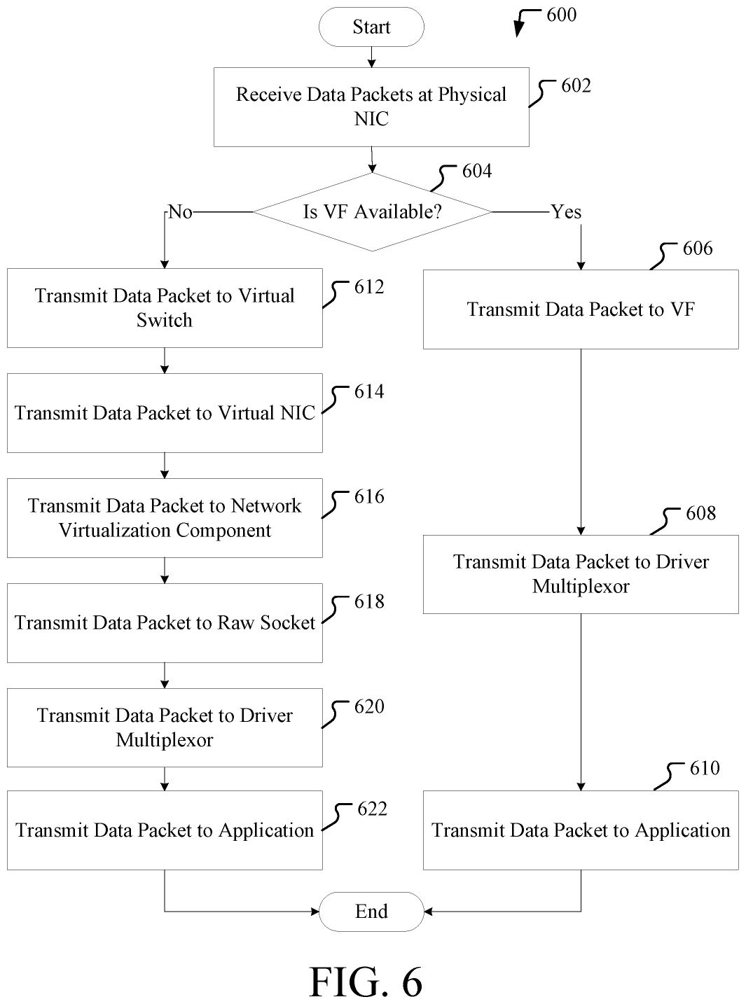

FIG. 6 illustrates an alternative example method for multiplexing driver data paths. Example method 600 describes transmitting data packets from a physical NIC to an application. Method 600 begins at operation 602, where a physical NIC, such as physical NIC 226, receives encapsulated data packets. In examples, the physical NIC is implemented in a host device comprising a guest environment.

At operation 604, the physical NIC determines whether a VF for processing the encapsulated data packets is available. The determination may comprise evaluating a component registry comprising entries for registered or active components of a guest environment. For instance, a hypervisor that is managing the guest environment may maintain a registry file of every currently active component of the guest environment. Alternatively, the determination may comprise interacting with components within a guest environment, such as querying a network virtualization component, such as network virtualization client 218, evaluating response messages (e.g., success, failure, acknowledge) received in response to attempting to provide data packets to a VF, such as VF 220, or interfacing with a driver multiplexer, such as driver multiplexor 208. As one example, the physical NIC provides a request to the driver multiplexer. The request causes the driver multiplexer to provide a determination of whether the VF is available, as discussed with respect to operation 504 of FIG. 5.

If the physical NIC determines the VF is available, method 600 proceeds to operation 606. At operation 606, the encapsulated data packets are provided to a VF implemented in kernel space of the guest environment. In some examples, the VF decapsulates the encapsulated data packets. Alternatively, the VF provides the encapsulated data packets to a component of the guest environment for decapsulation. For instance, the VF provides the encapsulated data packets to a network virtualization client, such as network virtualization client 218, and the network virtualization client decapsulates the encapsulated data packets. In such an example, the VF may be implemented in or separate from the network virtualization client. In other examples, the VF does not decapsulate or cause the decapsulation of the encapsulated data packets.

At operation 608, the VF provides the data packets to a driver multiplexer in the user space of a computing environment, such as driver multiplexor 208. In some examples, the VF provides encapsulated data packets to the driver multiplexer. In such examples, the driver multiplexer decapsulates the encapsulated data packets or provides the encapsulated data packets to a component of the guest environment for decapsulation, as described with respect to operation 606.

At operation 610, the driver multiplexer provides the data packets to an application in user space of the guest environment, such as application 204. In examples, the VF provides the data packets to the application such that the data packets bypass the network stack in the kernel space of the guest environment. The data packet data path described by operations 604, 606, 608, and 610 constitutes a hardware data path that provides faster data transmission speed than available using the data packet data path described by operations 612, 614, 616, 618, 620, and 622.

If, at operation 604, the physical NIC determines the VF is unavailable, method 600 proceeds to operation 612. In examples, the VF may be determined to be unavailable for various reasons, such as those described with respect to operation 504 of FIG. 5. At operation 612, the physical NIC transmits the encapsulated data packets to a virtual switch, such as virtual switch 224, that is within a virtual environment, such as virtual environment 201.

At operation 614, the virtual switch transmits the encapsulated data packets to a virtual NIC, such as virtual NIC 222. The virtual NIC is implemented within a virtual environment, but is implemented outside the boundary of the guest environment.

At operation 616, the virtual NIC provides the encapsulated data packets to a network virtualization component, such as network virtualization component 218. The network virtualization component is implemented inside the boundary of the guest environment and performs one or more types of decapsulation on the encapsulated data packets. As one example, the network virtualization component applies VM bus encapsulation to the data packets virtual switch encapsulation, and network driver encapsulation. After decapsulation, the data packets may comprise raw Ethernet frames.

At operation 618, the network virtualization component provides the decapsulated data packets to a raw socket, such as raw socket 214, provided by a raw socket interface, such as raw socket driver 210. In examples, the raw socket interface is implemented in user space of the guest environment and the raw socket is implemented in kernel space of the guest environment.

At operation 620, the raw socket transmits the decapsulated data packets to a driver multiplexer in the user space of a computing environment, as described with respect to operation 608.

At operation 622, the driver multiplexer transmits the decapsulated data packets to an application in user space of the guest environment, such as application 204. In examples, the data packet data path described by operations 612, 614, 616, 618, 620, and 622 constitutes a synthetic data path that provides slower data transmission speed than available using the data packet data path described by operations 604, 606, 608, and 610.

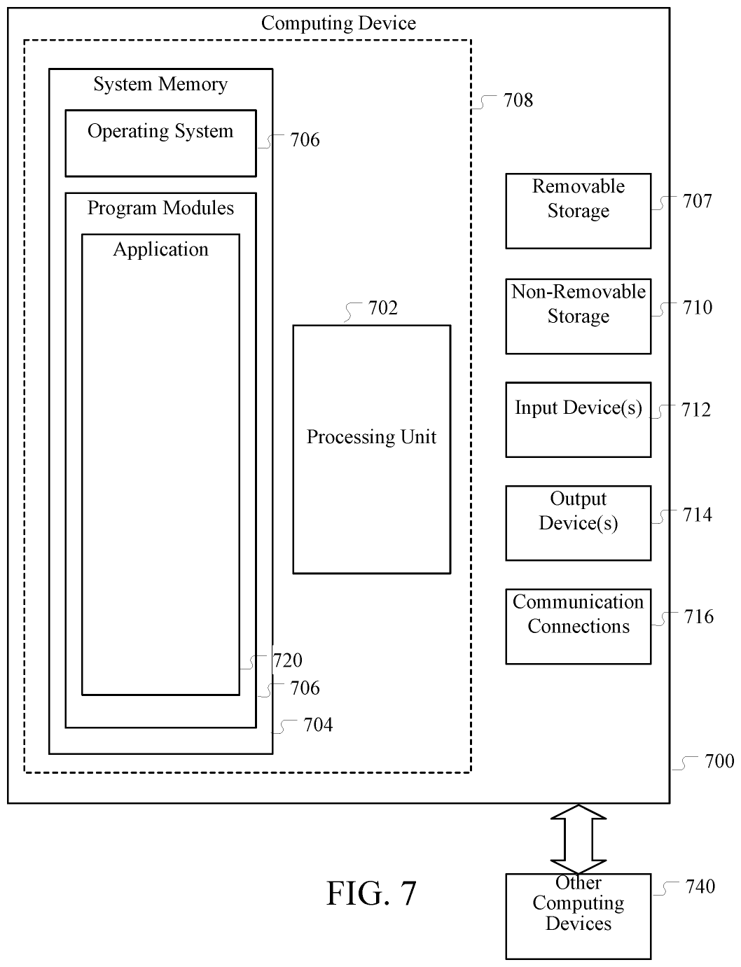

FIGS. 7-11 and the associated descriptions provide a discussion of a variety of operating environments in which aspects of the disclosure may be practiced. However, the devices and systems illustrated and discussed with respect to FIGS. 7-11 are for purposes of example and illustration, and, as is understood, a vast number of computing device configurations may be utilized for practicing aspects of the disclosure, described herein.

FIG. 7 is a block diagram illustrating physical components (e.g., hardware) of a computing device 700 with which aspects of the disclosure may be practiced. The computing device components described below are suitable for the computing devices and systems described above. In a basic configuration, the computing device 700 includes a processing system 702 comprising at least one processing unit and a system memory 704. Depending on the configuration and type of computing device, the system memory 704 may comprise volatile storage (e.g., random access memory), non-volatile storage (e.g., read-only memory), flash memory, or any combination of such memories.

The system memory 704 includes an operating system 705 and one or more program modules 706 suitable for running software application 720, such as one or more components supported by the systems described herein. The operating system 705, for example, is suitable for controlling the operation of the computing device 700.

Furthermore, embodiments of the disclosure may be practiced in conjunction with a graphics library, other operating systems, or any other application program. This basic configuration is illustrated in FIG. 7 by those components within a dashed line 708. The computing device 700 may have additional features or functionality. For example, the computing device 700 may include additional data storage devices (removable and/or non-removable) such as, for example, magnetic disks, optical disks, tape, and other computer readable media. Such additional storage is illustrated in FIG. 7 by a removable storage device 707 and a non-removable storage device 710.

The term computer readable media as used herein includes computer storage media. Computer storage media includes volatile and nonvolatile, removable and non-removable media implemented in any method or technology for storage of information, such as computer readable instructions, data structures, or program modules. The system memory 704, the removable storage device 707, and the non-removable storage device 710 are all computer storage media examples (e.g., memory storage). Computer storage media includes random access memory (RAM), read-only memory (ROM), electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” describes a signal that has one or more characteristics set or changed in such a manner as to encode information in the signal. By way of example, communication media may include wired media such as a wired network or direct-wired connection, and wireless media such as acoustic, RF, infrared, and other wireless media.

As stated above, a number of program modules and data files may be stored in the system memory 704. While executing on the processing system 702, the program modules 706 (e.g., application 720) perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 are integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 700 may also have one or more input device(s) 712 such as a keyboard, a mouse, a pen, a sound or voice input device, a touch or swipe input device, etc. Output device(s) 714 such as a display, speakers, a printer, etc. may also be included. The aforementioned devices are examples and others may be used. The computing device 700 includes one or more communication connections 716 allowing communications with other computing devices 740. Examples of suitable communication connections 716 include radio frequency (RF) transmitter, receiver, and/or transceiver circuitry; universal serial bus (USB), parallel, and/or serial ports.

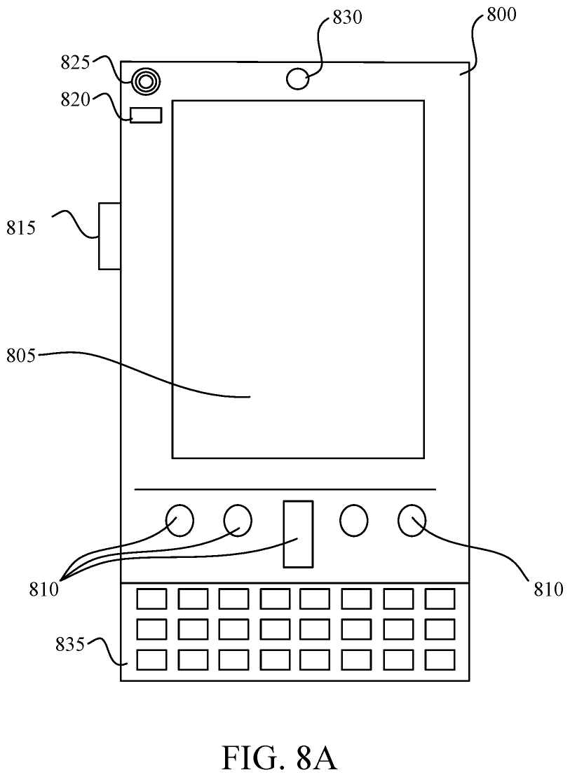

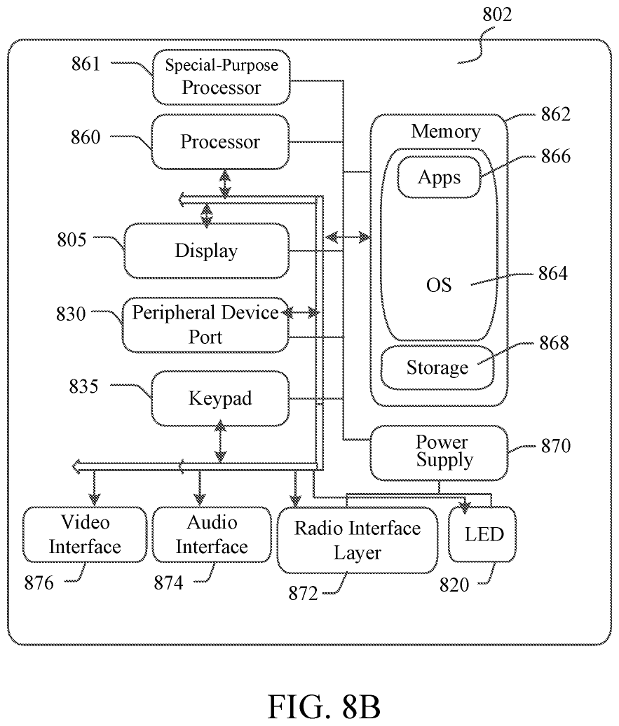

FIGS. 8A and 8B illustrate a mobile computing device 800, for example, a mobile telephone (e.g., a smart phone), wearable computer (such as a smart watch), a tablet computer, a laptop computer, and the like, with which embodiments of the disclosure may be practiced. In some aspects, the client device is a mobile computing device. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display).

If included, an optional side input element 815 allows further user input. The side input element 815 may be a rotary switch, a button, or any other type of manual input element. In alternative aspects, mobile computing device 800 incorporates more or less input elements. For example, the display 805 may not be a touch screen in some embodiments.

In yet another alternative embodiment, the mobile computing device 800 is a mobile telephone, such as a cellular phone. The mobile computing device 800 may also include an optional keypad 835. Optional keypad 835 is a physical keypad or a “soft” keypad generated on the touch screen display.

In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile computing device. That is, the mobile computing device can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system (OS) 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 is used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device described herein (e.g., search engine, extractor module, relevancy ranking module, answer scoring module).

The system 802 has a power supply 870, which may be implemented as one or more batteries. The power supply 870 might further include an external power source, such as an AC adapter or a powered docking cradle that supplements or recharges the batteries.

The system 802 also includes a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 are disseminated to the application programs 866 via the OS 864, and vice versa.

The visual indicator (e.g., light emitting diode (LED) 820) is used to provide visual notifications, and/or an audio interface 874 is used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor(s) (e.g., processor 860 and/or special-purpose processor 861) and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone also serves as an audio sensor to facilitate control of notifications, as will be described below. The system 802 further includes a video interface 876 that enables an operation of a peripheral device port 830 (e.g., an on-board camera) to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data may be readily transferred between computing devices for storage and use according to well-known data transfer and storage means, including electronic mail and collaborative data sharing systems.

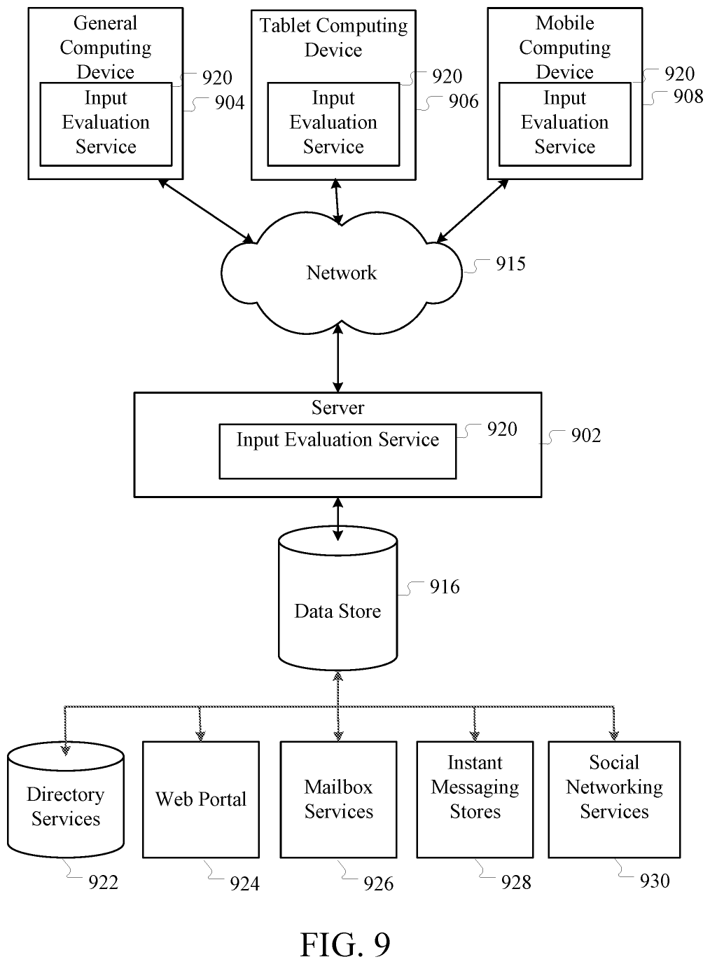

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using directory services 922, web portals 924, mailbox services 926, instant messaging stores 928, or social networking services 930.

An input evaluation service 920 may be employed by a client that communicates with server device 902, and/or input evaluation service 920 may be employed by server device 902. The server device 902 provides data to and from a client computing device such as a personal computer 904, a tablet computing device 906 and/or a mobile computing device 908 (e.g., a smart phone) through a network 915. By way of example, the computer system described above may be embodied in a personal computer 904, a tablet computing device 906 and/or a mobile computing device 908 (e.g., a smart phone). Any of these embodiments of the computing devices may obtain content from the data store 916, in addition to receiving graphical data useable to be either pre-processed at a graphic-originating system, or post-processed at a receiving computing system.

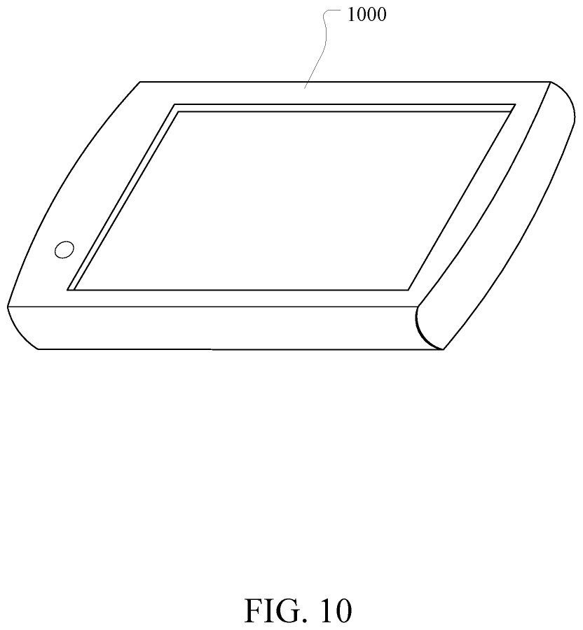

FIG. 10 illustrates an example of a tablet computing device 1000 that may execute one or more aspects disclosed herein. In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processing system; and
memory coupled to the processing system, the memory comprising computer executable instructions that, when executed by the processing system, perform operations comprising:
providing a data packet to a driver multiplexor implemented in user space of a computing environment;
determining, by the driver multiplexor, that a virtual function configured to transmit the data packet is available;
transmitting the data packet to a network interface component via the virtual function, wherein the network interface component is external to the computing environment.

2. The system of claim 1, wherein the computing environment is a guest environment implemented by a host device.

3. The system of claim 2, wherein the guest environment represents a virtual machine that is managed by a hypervisor of the host device.

4. The system of claim 1, wherein the data packet is provided to the driver multiplexor by an application in the user space of the computing environment via a software library, the software library enabling the offloading of data packets processing from kernel space of the computing environment to the user space of the computing environment.

5. The system of claim 1, wherein determining that the virtual function is available comprises at least one of:
querying the network virtualization component; or
evaluating response messages received in response to transmitting data packets to the virtual function.

6. The system of claim 1, wherein transmitting the data packet to the network interface component via the virtual function comprises:
using a virtual function driver to provide the driver multiplexor access to the virtual function, wherein the virtual function driver is shared across the user space of the computing environment and the kernel space of the computing environment.

7. The system of claim 1, wherein the virtual function is implemented in the network virtualization component.

8. The system of claim 1, wherein the virtual function enables the data packet to be transmitted from the kernel space of the computing environment to the user space of the computing environment such that the data packet bypasses a network stack of the computing environment.

9. The system of claim 1, wherein the virtual function enables the data packet to be transmitted from the kernel space of the computing environment to the network interface component such that the data packet bypasses a network stack of a computing device that is hosting the computing environment.

10. The system of claim 1, wherein a data path for transmitting the data packet to a network interface component via the virtual function is a hardware data path.

11. The system of claim 1, wherein the virtual function is determined to be unavailable due to an operational failure of at least one of:
the virtual function;
the network virtualization component; or
the network interface component.

12. A system comprising:
a processing system; and
memory coupled to the processing system, the memory comprising computer executable instructions that, when executed by the processing system, perform operations comprising:
providing a data packet to a driver multiplexor implemented in user space of a computing environment;
determining, by the driver multiplexor, that a virtual function configured to transmit the data packet is unavailable;
transmitting the data packet to a network virtualization component via a raw socket, wherein the network virtualization component is internal to the computing environment and external to the user space of the computing environment;
transmitting the data packet to a virtual switch that is external to the computing environment; and
transmitting the data packet to the network interface component.

13. The system of claim 12, wherein transmitting the data packet to the network virtualization component via the raw socket comprises:
using a raw socket driver to provide the driver multiplexor access to the raw socket, wherein the raw socket driver is implemented in the user space of the computing environment and the raw socket is implemented in kernel space of the computing environment.

14. The system of claim 12, wherein the network virtualization component is implemented in kernel space of the computing environment.

15. The system of claim 12, wherein the network virtualization component encapsulates the data packet.

16. The system of claim 12, wherein the data packet is a raw Ethernet frame.

17. The system of claim 12, wherein the raw socket is associated with a filter mechanism, the filter mechanism enabling monitoring and filtering of the data packet as the data packet is being transmitted via the raw socket.

18. The system of claim 12, wherein transmitting the data packet to the physical network interface card comprises:
transmitting, by the network virtualization component, the data packet to a virtual network interface card; and
transmitting, by the network interface card, the data packet to a virtual switch.

19. The system of claim 18, wherein the virtual network interface card and the virtual switch are implemented external to the guest environment and internal to a virtual environment comprising the guest environment.

20. A device comprising:
a processor; and
memory coupled to the processor, the memory comprising computer executable instructions that, when executed by the processor, perform operations comprising:
providing a data packet to a driver multiplexor implemented in user space of a computing environment;
determining, by the driver multiplexor, that a virtual function configured to transmit the data packet is available;
transmitting the data packet to a network interface component via the virtual function, wherein the network interface component is external to the computing environment.
